(19) United States
(12) Patent Application Publication
(10) Pub. No.: US 2026/0163825 A1
(43) Pub. Date: Jun. 11, 2026

(54) MEASUREMENT REPORTING IN WIRELESS COMMUNICATIONS

(71) Applicant: LG ELECTRONICS INC., Seoul (KR)

(72) Inventor: Sangwon KIM, Seoul (KR)

(73) Assignee: LG ELECTRONICS INC., Seoul (KR)

(21) Appl. No.: 18/708,537

(22) PCT Filed: Dec. 26, 2022
(86) PCT No.: PCT/KR2022/021287

§ 371 Date: May 8, 2024

(30) Foreign Application Priority Data
Dec. 31, 2021 (KR) 10-2021-0194609

(51) Int. Cl. H04L 41/5067; H04W 24/10

(52) U.S. Cl. CPC H04L 41/5067; H04W 24/10

(57) ABSTRACT

The present disclosure relates to a measurement reporting in wireless communications. According to an embodiment of the present disclosure, a user equipment (UE) may determine whether to transmit a quality of experience (QoE) measurement result via a signalling radio bearer (SRB) among one or more SRBs related to cell groups based on at least one of i) whether one or more of the cell groups are congested, or ii) whether a specific SRB is included in the one or more SRBs. Therefore, the QoE measurement result can be properly provided from the UE to the network even when the network is congested.

### CROSS-REFERENCE TO RELATED APPLICATION(S)

This application is the National Stage filing under 35 U.S.C. 371 of International Application No. PCT/KR2022/021287, filed on Dec. 26, 2022, which claims the benefit of earlier filing date and right of priority to Korean Application No. 10-2021-0194609, filed on Dec. 31, 2021, the contents of which are all incorporated by reference herein in their entirety.

### TECHNICAL FIELD

The present disclosure relates to a measurement reporting in wireless communications.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications 1 (mMTC), ultra-reliable and low latency communications (URLLC), etc. The NR shall be inherently forward compatible.

In wireless communications, UE may perform a measurement reporting to a network so as to be provided with better service by the network based on the measurement reporting. To perform the measurement reporting, UE may perform measurements, collect measurement results, and transmit a measurement report including the measurement results to the network. For example, the measurement may comprise application layer measurement and/or quality of experience (QoE) measurements.

### SUMMARY

An aspect of the present disclosure is to provide method and apparatus for measurement reporting in a wireless communication system.

Another aspect of the present disclosure is to provide method and apparatus for QoE measurement reporting in a wireless communication system.

According to an embodiment of the present disclosure, a method performed by a user equipment (UE) in a wireless communication system comprises: receiving a measurement configuration for quality of experience (QoE); obtaining a QoE measurement result based on the measurement configuration for QoE, wherein one or more signalling radio bearers (SRBs) related to cell groups are configured for reporting the QoE measurement result; and determining whether to transmit the QoE measurement result via an SRB among the one or more SRBs based on at least one of i) whether one or more of the cell groups are congested, or ii) whether a specific SRB is included in the one or more SRBs.

According to an embodiment of the present disclosure, a method performed by a network node adapted to operate in a wireless communication system comprises: transmitting, to a user equipment (UE), a measurement configuration for quality of experience (QoE); and monitoring a QoE measurement result based on the measurement configuration for QoE from the UE, wherein one or more signalling radio bearers (SRBs) related to cell groups are configured to the UE for reporting the QoE measurement result, and wherein whether to transmit the QoE measurement result via an SRB among the one or more SRBs is determined based on at least one of i) whether one or more of the cell groups are congested, or ii) whether a specific SRB is included in the one or more SRBs.

According to various embodiments of the present disclosure, apparatuses implementing the above methods are described.

The present disclosure can have various advantageous effects.

For example, when a Uu interface between UE and a certain CG is congested, UE may report the QoE measurement results using another CG not congested so that the network can obtain the QoE measurement results as soon as the QoE measurement is completed.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a dual connectivity (DC) architecture to which technical features of the present disclosure can be applied.

FIG. 11 shows an example of a procedure for application layer measurement reporting according to an embodiment of the present disclosure.

FIG. 12 shows an example of a method performed by a UE according to an embodiment of the present disclosure.

FIG. 13 shows an example of a signal flow for QoE measurement reporting according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’, ‘channel state/reference signal received power (RSRP)’ and ‘reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

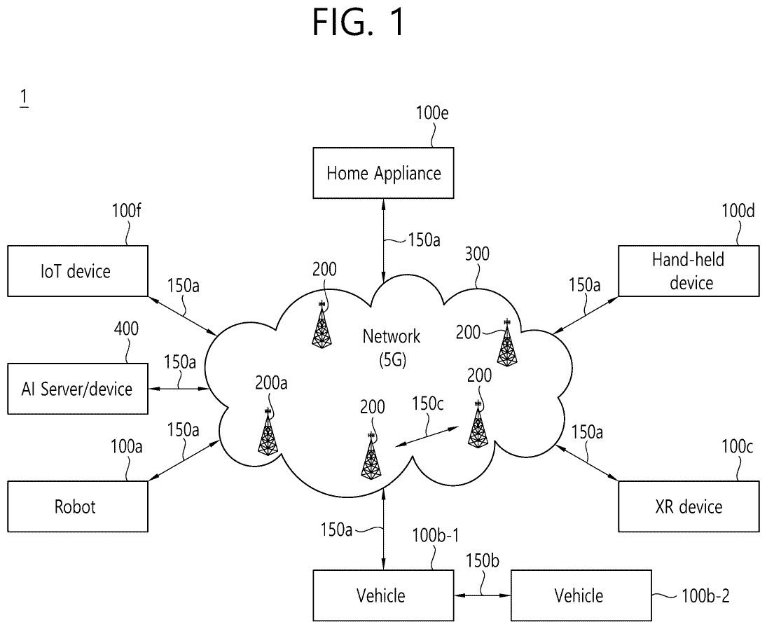

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

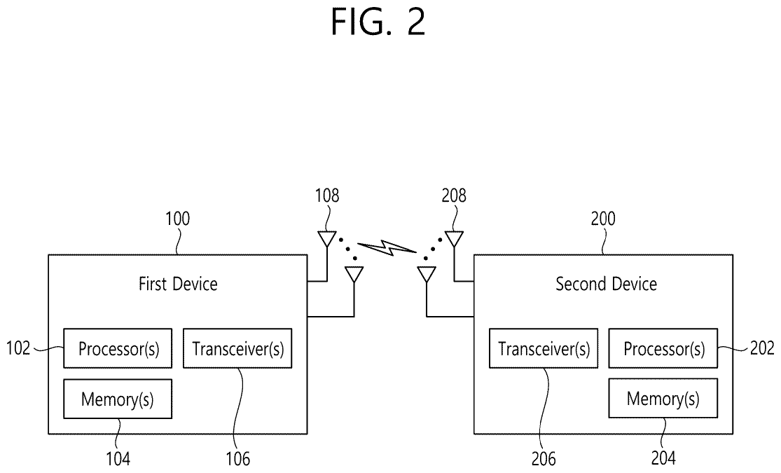

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to/adapted to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to/adapted to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to/adapted to include the modules, procedures, or functions. Firmware or software configured to/adapted to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to/adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to/adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to/adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

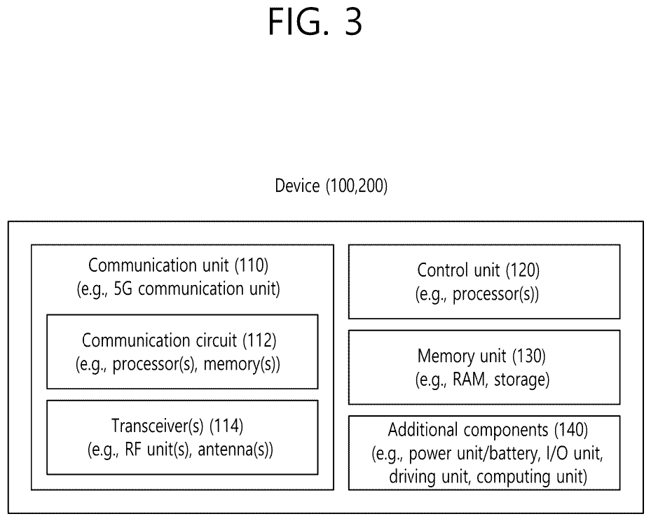

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

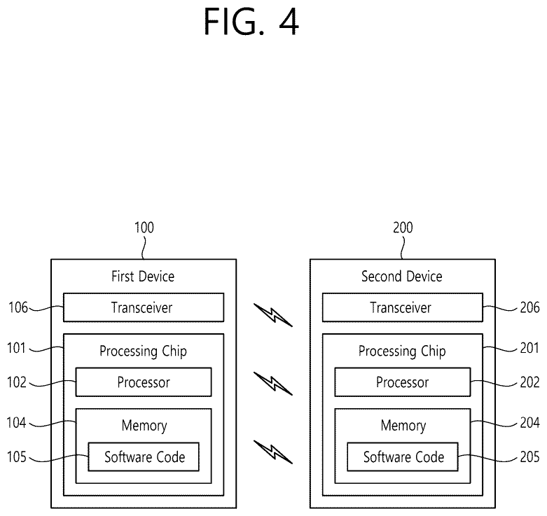

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

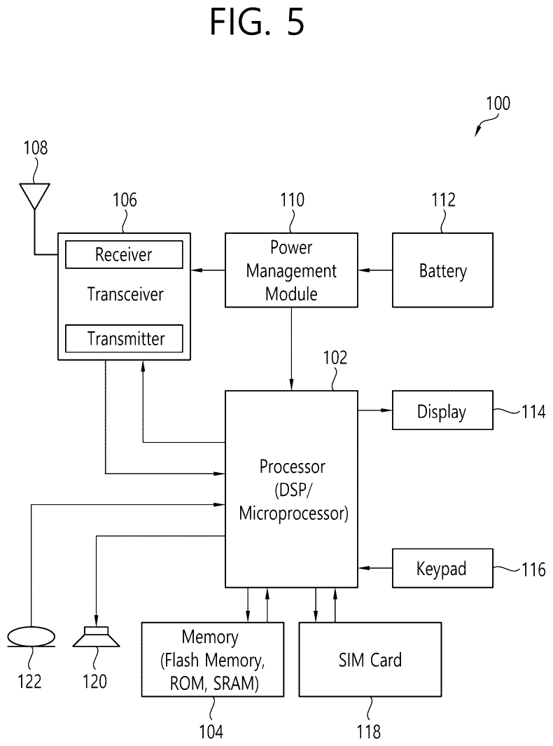

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to/adapted to implement the descriptions, functions, procedures, suggestions, methods and/or operational flowcharts disclosed in the present disclosure. The processor 102 may be configured to/adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

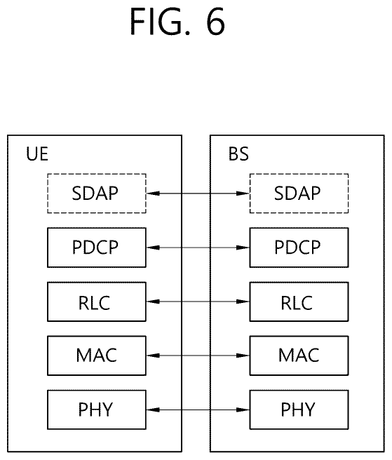

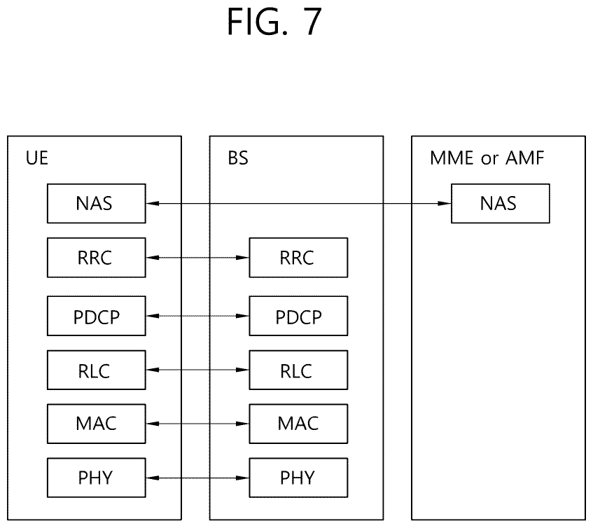

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

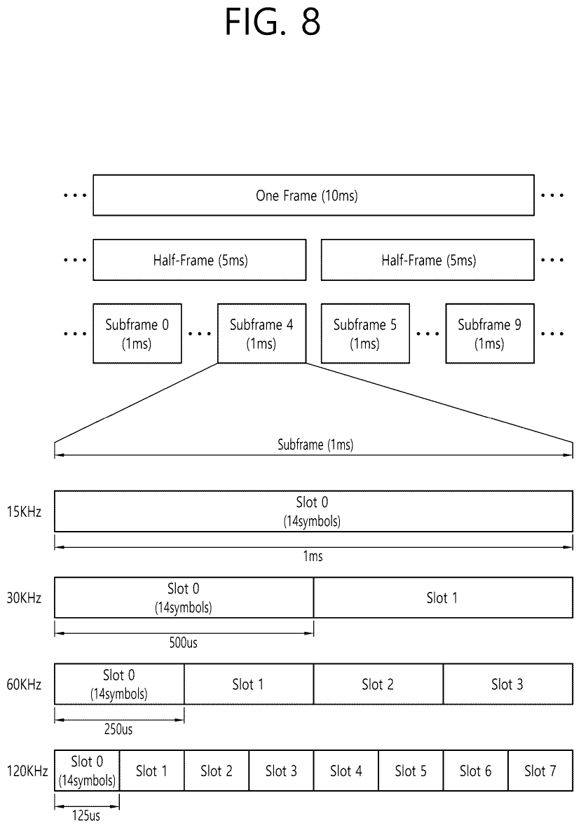

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and/subframe,u symb OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}-1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

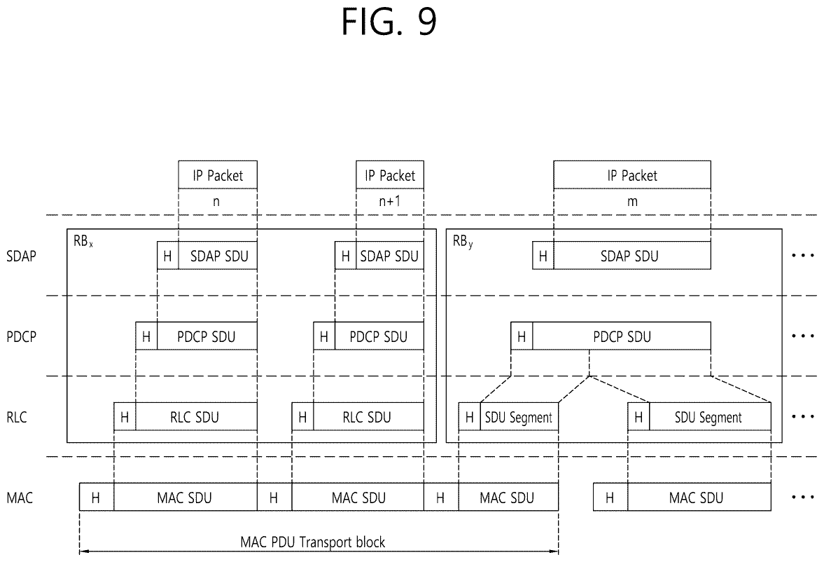

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

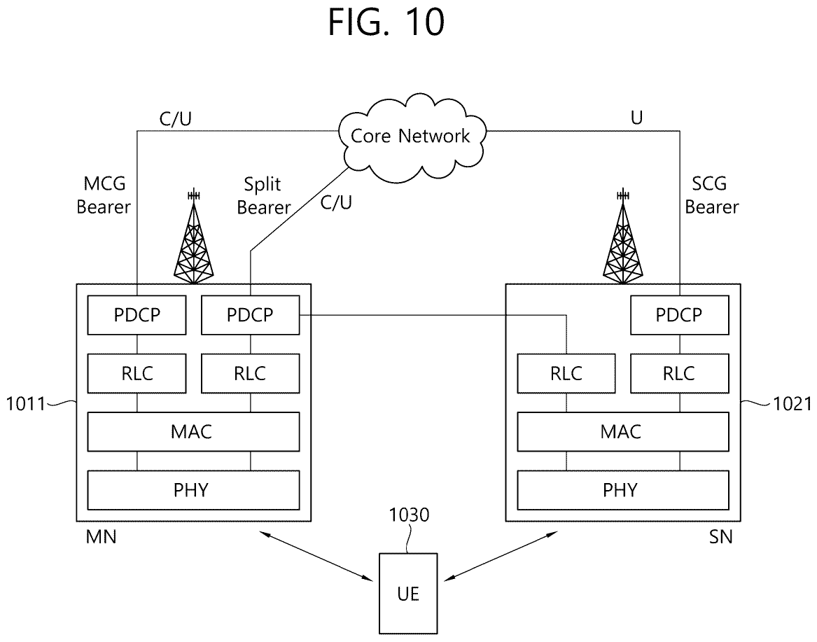

FIG. 10 shows an example of a dual connectivity (DC) architecture to which technical features of the present disclosure can be applied.

Referring to FIG. 10, MN 1011, SN 1021, and a UE 1030 communicating with both the MN 1011 and the SN 1021 are illustrated. As illustrated in FIG. 10, DC refers to a scheme in which a UE (e.g., UE 1030) utilizes radio resources provided by at least two RAN nodes comprising a MN (e.g., MN 1011) and one or more SNs (e.g., SN 1021). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 1011) refers to a main RAN node providing services to a UE in DC situation. SN (e.g., SN 1021) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 10, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 10, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 10, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 10, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, quality of experience (QoE) measurement collection is described.

The QoE Measurement Collection function enables collection of application layer measurements from the UE. The supported service types are:
QoE Measurement Collection for DASH streaming services;
QoE Measurement Collection for MTSI services;
QoE Measurement Collection for VR services.

The QoE measurement collection is supported in RRC_CONNECTED state and/or RRC_INACTIVE state. Both signalling based and management based QoE measurement collection are supported. In the Uu interface, QoE measurement is equivalent to application layer measurement.

### 1. QoE Measurement Collection Activation and Reporting

The QoE measurement collection is activated in the gNB either by direct configuration from the OAM system (management-based activation), or by signalling from the OAM via the 5GC (signalling-based activation), containing UE-associated QoE configuration. One or more QoE measurement collection jobs can be activated at a UE per service type, and each QoE measurement configuration is uniquely identified by a QoE reference. When the UE is configured with MR-DC, only the MN can configure the QoE configuration.

For signalling-based QoE measurements, the OAM initiates the QoE measurement activation for a specific UE via the 5GC, and the gNB receives one or more QoE measurement configurations by means of UE-associated signalling. The QoE measurement configuration for signalling-based activation includes an application layer measurement configuration list and the corresponding information for QoE measurement collection, e.g., QoE reference, service type, MCE IP address, slice scope, area scope, MDT alignment information and the indication of available RAN visible QoE metrics.

For management-based QoE measurement activation, the OAM sends one or more QoE measurement configurations directly to the gNB. The QoE measurement configuration for management-based activation also includes an application layer measurement configuration list and the corresponding information for QoE measurement collection. The gNB selects UE(s) that meet the required QoE measurement capability, area scope and slice scope.

Application layer measurement configuration received by the gNB from OAM or CN is encapsulated in a transparent container, which is forwarded to a UE as Application layer configuration in the RRCReconfiguration message (there can be multiple configurations in the same message). Application layer measurement reports received from UE's application layer are encapsulated in a transparent container and sent to the network in the MeasurementReportAppLayer message. The UE can send multiple application layer measurement reports to the gNB in one MeasurementReportAppLayer message. In order to allow the transmission of application layer measurement reports which exceed the maximum PDCP SDU size, segmentation of the MeasurementReportAppLayer message may be enabled by the gNB. An RRC identifier conveyed in the RRC signalling is used to identify the application layer measurement configuration and report between the gNB and the UE. The RRC identifier is mapped to the QoE reference in the gNB, and the gNB forwards the application layer measurement report to MCE together with the QoE reference. The gNB can release one or multiple application layer measurement configurations from the UE in one RRCReconfiguration message at any time. The UE may additionally be configured by the gNB to report when a QoE measurement session starts or stops for a certain application layer measurement configuration.

### 2. QoE Measurement Collection Deactivation

The QoE Measurement Collection deactivation permanently stops all or some of the QoE measurement collection jobs towards a UE, resulting in the release of the corresponding QoE measurement configuration(s) in the UE. The deactivation of QoE measurement collection is supported by using UE-associated signalling. A list of QoE references is used to deactivate the corresponding QoE measurement collection job(s).

Upon reception of the QoE release message in an application layer measurement configuration, the UE discards any unsent application layer measurement reports corresponding to the released application layer configuration. The UE discards the reports received from application layer when it has no associated application layer measurement configuration configured.

The network can replace a QoE measurement configuration with another one by deactivating an existing QoE measurement configuration and activating another QoE measurement configuration of the same QoE measurement configuration type.

3. Handling of QMC during RAN Overload

The QoE measurement collection pause/resume procedure is used to pause/resume reporting of one or multiple QoE measurement configurations in a UE in RAN overload situation.

The gNB can use the RRCReconfiguration message to temporarily stop the UE from sending application layer measurement reports associated with one or multiple application layer measurement configurations. When the UE receives the QoE measurement collection pause indication, the UE temporarily stores application layer measurement reports in AS layer. When the UE receives the QoE measurement collection resume indication, the UE sends the stored application layer measurement reports to the gNB.

### 4. QoE Measurement Handling in RRC_IDLE and RRC_INACTIVE States

If the UE enters RRC_INACTIVE, the UE AS configuration for the QoE is stored in the UE Inactive AS context.

If the UE enters RRC_IDLE state, the UE releases all application layer measurement configurations.

### 5. QoE Measurement Continuity for Mobility

The QoE measurement collection continuity for intra-system intra-RAT mobility is supported, with the Area Scope parameters configured by the OAM, where the network is responsible for keeping track of whether the UE is inside or outside the Area Scope. A UE continues an ongoing QoE measurement even if it leaves the Area Scope, unless the network indicates to the UE to release the QoE configuration.

For the RRC_CONNECTED state mobility, the source gNB may transmit the QoE measurement configuration(s) and/or the information related to the configuration(s) of a specific UE to the target gNB via XnAP or NGAP. For signalling-based QoE, the service type, QoE reference, MCE IP address, measurement configuration application layer id, MDT alignment information, area scope, slice support list for QMC and measurement status are passed to the target gNB. For management-based QoE, the service type, measurement configuration application layer id, MCE IP address and QoE measurement status are passed to the target gNB. For RRC_INACTIVE state mobility, QoE measurement configuration(s) of a specific UE can be retrieved from the gNB hosting the UE context when it resumes to the RRC_CONNECTED state. Multiple sets of QoE measurement configurations should be supported during mobility.

For signalling based QoE, at handover to a target gNB that supports QoE, the target gNB decides which of the application layer measurement configurations should be kept or released, e.g. based on application layer measurement configuration information received from the source gNB in Xn/NG signalling.

When the UE resumes the connection with a gNB that does not support QoE, the UE releases all application layer measurement configurations.

### 6. RAN Visible QoE Measurements

RAN visible QoE measurements are configured to the UE by the gNB, where a subset of configured QoE metrics is reported from the UE to the gNB as an explicit IE readable by the gNB. The RAN visible QoE measurements can be utilized by the gNB for network optimization. The RAN visible QoE measurements are supported for the DASH streaming and VR services. The gNB configures the RAN visible QoE measurement to collect all or some of the available RAN visible QoE metrics, where the indication of metric availability is received from the OAM or the 5GC. The set of available RAN visible QoE metrics is a subset of the metrics which are already configured as part of QoE measurement configuration encapsulated in the application layer container. The PDU session ID(s) corresponding to the service that is subject to QoE measurements can also be reported by the UE along with the RAN visible QoE measurement results.

The RAN visible QoE measurements can be reported with a reporting periodicity different from the one of the corresponding encapsulated QoE measurements. If there is no reporting periodicity defined in the RAN visible QoE configuration, RAN visible QoE measurement reports are sent together with the encapsulated QoE measurement reports.

Multiple simultaneous RAN visible application layer measurement configurations and reports can be supported for RAN visible application layer measurement, and each RAN visible application layer measurement configuration and report is identified by the same RRC identifier as the application layer measurement configuration and measurement report. After receiving the RAN visible application layer measurement configuration, the UE RRC layer forwards the configuration to the application layer, indicating the service type, the RRC identifier and the periodicity. RAN visible application layer configuration can only be configured if there is a corresponding application layer measurement configuration for the same service type configured at the UE. The application layer sends the RAN visible application layer measurement report associated with the RRC identifier to the UE's AS layer. UE can send both RAN visible application layer measurement reports and the application layer measurement reports to the gNB in the same MeasurementReportAppLayer message. The gNB can release one or multiple RAN visible application layer measurement configurations from the UE in one RRCReconfiguration message at any time.

During RAN overload, the UE continues to report the configured RAN visible application layer measurements, when the corresponding non RAN visible application layer measurement reporting is paused.

### 7. Alignment of MDT and QoE Measurements

The radio-related measurements may be collected via immediate MDT for all types of supported services for the purpose of QoE analysis. The MCE/TCE performs the correlation of the immediate MDT measurement results and the QoE measurement results collected at the same UE.

The following is supported:
Alignment between a signalling-based QoE measurement and a signalling-based MDT measurement. In this case, the signalling-based QoE configuration sent to the gNB includes the NG-RAN Trace ID of the signalling-based MDT measurement.
Alignment between a management-based QoE measurement and a management-based MDT measurement.

The UE configured with QoE measurements sends an indication to inform the gNB about the start or the stop of a QoE measurement session of configured QoE measurements. The gNB can activate the MDT measurements that are to be aligned with the QoE measurements performed by the UE upon/after receiving the QoE measurement session start indication from the UE. The gNB may activate the MDT measurements upon/after receiving the MDT activation message from the OAM. The gNB can deactivate the aligned MDT measurements according to an OAM command which may, e.g., be triggered by the session stop indication.

The gNB includes time stamp information to the QoE measurement reports to enable the correlation of corresponding measurement results of MDT and QoE at the MCE/TCE. In addition, the gNB includes the MDT session identifiers (Trace Reference and Trace Recording Session Reference) in the corresponding QoE measurement report.

In some implementations, QoE measurements in RRC_INACTIVE state can be supported, for multicast-broadcast service (MBS).

In some implementations, the UE may store its QoE configuration when going to RRC INACTIVE state for potential use when the UE moves back to RRC_Connected state.

In some implementations, the UE Inactive AS context includes the UE AS configuration for the QoE (it is not released when UE goes to Inactive).

In some implementations, application layer and/or AS layer is responsible for storing QoE reports when the UE receives QoE pause indication

In some implementations, the QoE container received from application layer may be discarded during pause.

In some implementations, if the UE enters IDLE state, UE may release all of the QoE measurement configurations.

In some implementations, at reception of QoE release, the UE may discard any unsent QoE reports corresponding to the released QoE configuration.

In some implementations, pause resume may affect all configurations or act selectively per configuration.

In some implementations, the RRC layer may forward the MeasConfigAppLayerId together with the QoE configuration to the application layer.

In some implementations, when the UE resumes the connection in a gNB supporting QoE, the target gNB may explicitly indicate which QoE measurement configurations should be kept by the UE during RRC resume procedure, e.g. in RRCResume message. The UE may release all QoE measurement configurations not indicated by the gNB for restoration. The indication may be per QoE configuration or common for all QoE configurations.

In some implementations, during the handover to target gNB which supports QoE, the target gNB decides which QoE configurations to keep and which to release during a handover, e.g. based on QoE configuration information received from the source gNB in Xn/Ng signalling including the RRC container.

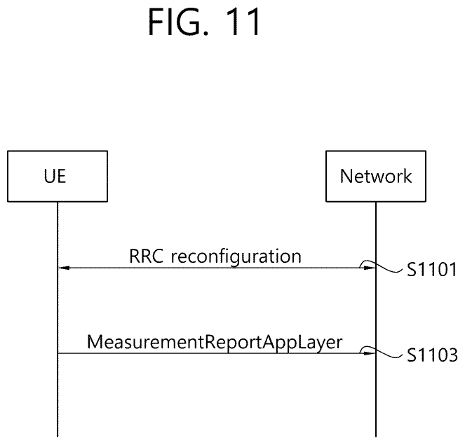

FIG. 11 shows an example of a procedure for application layer measurement reporting according to an embodiment of the present disclosure.

The purpose of the procedure for application layer measurement reporting is to send application layer measurement reports to the network. A UE capable of application layer measurement reporting in RRC_CONNECTED may initiate the procedure when configured with application layer measurement, i.e. when appLayerMeasConfig and SRB4 have been configured by the network.

Referring to FIG. 11, in step S1101, the UE and/or network may perform RRC reconfiguration. In this step, the UE may receive, from the network, RRCReconfiguration message including appLayerMeasConfig (i.e., QoE measurement configuration and/or measurement configuration for QoE). The appLayerMeasConfig indicates configuration of application layer measurements, and includes the following information elements (IEs) as shown in table 5 below:

TABLE 5

| | |
|---|---|
| AppLayerMeasConfig-r17 ::= | SEQUENCE { |
| measConfigAppLayerToAddModList-r17 | SEQUENCE (SIZE |
| (1..maxNrofAppLayerMeas-r17)) OF MeasConfigAppLayer-r17 | OPTIONAL, -- Need |

N

| | |
|---|---|
| measConfigAppLayerToReleaseList-r17 | SEQUENCE (SIZE |
| (1..maxNrofAppLayerMeas-r17)) OF MeasConfigAppLayerId-r17 | OPTIONAL, -- Need N |
| rrc-SegAllowed-r17 | ENUMERATED {enabled} |

```
OPTIONAL, -- Need R
    ...
  }
```

| | |
|---|---|
| MeasConfigAppLayer-r17 ::= | SEQUENCE { |
| measConfigAppLayerId-r17 | MeasConfigAppLayerId-r17, |
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, |
| vr, spare5, spare4, spare3, spare2, spare1} | OPTIONAL, -- Need M |
| pauseReporting-r17 | BOOLEAN |

OPTIONAL, -- Need M

| | |
|---|---|
| transmissionOfSessionStartStop-r17 | BOOLEAN |

OPTIONAL, -- Need M

| | |
|---|---|
| ran-VisibleParameters-r17 | SetupRelease {RAN- |
| VisibleParameters-r17} | OPTIONAL, -- Cond |

```
ServiceType
    ...
  }
```

| | |
|---|---|
| RAN-VisibleParameters-r17 ::= | SEQUENCE { |
| ran-VisiblePeriodicity-r17 | ENUMERATED {ms120, ms240, |
| ms480, ms640, ms1024} | OPTIONAL, -- Need S |
| numberOfBufferLevelEntries-r17 | INTEGER (1..8) |
| OPTIONAL, -- Need R | |
| reportPlayoutDelayForMediaStartup-r17 | BOOLEAN |

```
OPTIONAL, -- Need M
    ...
  }
```

In table 5:—measConfigAppLayerContainer contains configuration of application layer measurements;
pauseReporting indicates whether the transmission of measReportAppLayerContainer is paused or not. Value true indicates the transmission of measReportAppLayerContainer is paused; value false indicates the transmission of measReportAppLayerContainer is not paused;
ran-VisibleParameters indicates whether RAN visible application layer measurements shall be reported or not;
rrc-SegAllowed indicates that RRC segmentation of MeasurementReportAppLayer is allowed. It may be present only if the UE supports RRC segmentation of the MeasurementReportAppLayer message in UL;
serviceType indicates the type of application layer measurement. Value streaming indicates Quality of Experience Measurement Collection for streaming services, value mtsi indicates Quality of Experience Measurement Collection for MTSI. value vr indicates Quality of Experience Measurement Collection for VR service. The network always configures serviceType when application layer measurements are initially configured and at fullConfig;
transmissionOfSessionStartStop indicates whether the UE shall transmit indications when sessions in the application layer start and stop. The UE transmits a session start indication upon configuration of this field if a session already has started in the application layer;
numberOfBufferLevelEntries contains the maximum number of buffer level entries that can be reported for RAN visible application layer measurements;
ran-VisiblePeriodicity indicates the periodicity of RAN visible application layer measurements reporting. Value ms120 indicates 120 ms, value ms240 indicates 240 ms and so on;
reportPlayoutDelayForMediaStartup indicates whether the UE shall report Playout Delay for Media Startup for RAN visible application layer measurements.

The UE shall:
1> if measConfigAppLayerToReleaseList is included in appLayerMeasConfig within RRCReconfiguration or RRCResume:
2> for each measConfigAppLayerId value included in the measConfigAppLayerToReleaseList:
3>forward the measConfigAppLayerId and inform upper layers about the release of the application layer measurement configuration including any RAN visible application layer measurement configuration;
3>discard any application layer measurement report received from upper layers;
3>consider itself not to be configured to send application layer measurement report for the measConfigAppLayerId.
1> if measConfigAppLayer ToAddModList is included in appLayerMeasConfig within RRCReconfiguration or RRCResume:
2> for each measConfigAppLayerId value included in the measConfigAppLayerToAddModList:
3> if measConfigAppLayerContainer is included for the corresponding MeasConfigAppLayer configuration:
4>forward the measConfigAppLayerContainer, the measConfigAppLayerId and the serviceType to upper layers considering the serviceType;
3>consider itself to be configured to send application layer measurement report for the measConfigAppLayerId in accordance with 5.7.16;
3>forward the transmissionOfSessionStartStop, if configured, and measConfigAppLayerId to upper layers considering the serviceType;
3> if ran-VisibleParameters is set to setup and the parameters have been received:
4>forward the measConfigAppLayerId, the ran-VisiblePeriodicity, if configured, the numberOfBufferLevelEntries, if configured, and the reportPlayoutDelayForMediaStartup, if configured, to upper layers considering the serviceType;
3> else if ran-VisibleParameters is set to release:
4>forward the measConfigAppLayerId and inform upper layers about the release of the RAN visible application layer measurement configuration;
3> if pauseReporting is set to true:
4> if at least one segment, but not all segments, of a segmented MeasurementReportAppLayer message containing an application layer measurement report associated with the measConfigAppLayerId has been submitted to lower layers for transmission:
5>submit the remaining segments of the MeasurementReportAppLayer message to lower layers for transmission;
4>suspend submitting application layer measurement report containers to lower layers for the application layer measurement configuration associated with the measConfigAppLayerId;
4> store any previously or subsequently received application layer measurement report containers associated with the measConfigAppLayerId for which no segment, or full message, has been submitted to lower layers for transmission;
3> else if pauseReporting is set to false and if transmission of application layer measurement report containers has previously been suspended for the application layer measurement configuration associated with the measConfigAppLayerId:
4>submit stored application layer measurement report containers to lower layers, if any, for the application layer measurements configuration associated with the measConfigAppLayerId;
4>resume submitting application layer measurement report containers to lower layers for the application layer measurement configuration associated with the measConfigAppLayerId;

The UE may discard reports when the memory reserved for storing application layer measurement reports becomes full.

The transmission of RAN visible application layer measurement reports and appLayerSessionStatus is not paused when pauseReporting is set to true.

In step S1103, the UE may transmit/report MeasurementReportAppLayer message to the network via SRB4. The MeasurementReportAppLayer message is used for sending application layer measurement report, and includes the following IEs (e.g., QoE measurement result) as shown in table 6 below:

TABLE 6

| | |
|---|---|
| MeasurementReportAppLayer-r17 ::= | SEQUENCE { |
| criticalExtensions | CHOICE { |
| measurementReportAppLayer-r17 | MeasurementReportAppLayer- |

r17-IEs,

| | |
|---|---|
| criticalExtensionsFuture | SEQUENCE { } |

```
    }
  }
```

| | |
|---|---|
| MeasurementReportAppLayer-r17-IEs := | SEQUENCE { |

measurementReportAppLayerList-r17
MeasurementReportAppLayerList-r17,

| | |
|---|---|
| lateNonCriticalExtension | OCTET STRING |

OPTIONAL,

| | |
|---|---|
| nonCriticalExtension | SEQUENCE{ } |

OPTIONAL
}

| | |
|---|---|
| MeasurementReportAppLayerList-r17 | ::= SEQUENCE (SIZE |

(1..maxNrofAppLayerMeas-r17)) OF MeasReportAppLayer-r17

| | |
|---|---|
| MeasReportAppLayer-r17 ::= | SEQUENCE { |
| measConfigAppLayerId-r17 | MeasConfigAppLayerId-r17, |
| measReportAppLayerContainer-r17 | OCTET STRING |

OPTIONAL,

| | |
|---|---|
| appLayerSessionStatus-r17 | ENUMERATED {started, stopped} |

OPTIONAL,

| | |
|---|---|
| ran-VisibleMeasurements-r17 | RAN-VisibleMeasurements-r17 |

OPTIONAL
}

| | |
|---|---|
| RAN-VisibleMeasurements-r17 ::= | SEQUENCE { |
| appLayerBufferLevelList-r17 | SEQUENCE (SIZE (1..8)) OF |
| AppLayerBufferLevel-r17 | OPTIONAL, |
| playoutDelayForMediaStartup-r17 | INTEGER (0..30000) |

OPTIONAL,

| | |
|---|---|
| *274 pdu-SessionIdList-r17 | SEQUENCE (SIZE |
| (1..maxNrofPDU-Sessions-r17)) OF PDU-SessionID | OPTIONAL, |

```
    ...
  }
  AppLayerBufferLevel-r17 ::= INTEGER (0..30000)
```

In table 6:—appLayerSessionStatus indicates that an application layer measurement session in the application layer starts or ends;
measReportAppLayerContainer contains application layer measurement report;
ran-VisibleMeasurements contains the configuration of RAN visible application layer measurement parameters;
appLayerBufferLevelList indicates a list of application layer buffer levels, and each AppLayerBufferLevel indicates the application layer buffer level in ms. Value 0 corresponds to 0 ms, value 1 corresponds to 10 ms, value 2 corresponds to 20 ms and so on. If the buffer level is larger than the maximum value of 30000 (5 minutes), the UE reports 30000;
playoutDelayForMediaStartup indicates the application layer playout delay for media start-up in ms. Value 0 corresponds to 0 ms, value 1 corresponds to 1 ms, value 2 corresponds to 2 ms and so on. If the playout delay for media start-up is larger than the maximum value of 30000 ms, the UE reports 30000;
pdu-SessionIdList contains the identity of the PDU session, or the identities of the PDU sessions, used for application data flows subject to the RAN visible application layer measurements.

Upon initiating the procedure for application layer measurement reporting, the UE shall:
1> for each measConfigAppLayerId received from upper layers:
2> if the UE AS has received application layer measurement report from upper layers which has not been transmitted; and
2> if the application layer measurement reporting has not been suspended for the measConfigAppLayerId associated with the application layer measurement report:
3> set the measReportAppLayerContainer in the MeasurementReportAppLayer message to the received value in the application layer measurement report;
2> set the measConfigAppLayerId in the MeasurementReportAppLayer message to the value of the measConfigAppLayerId received together with application layer measurement report information;
2> if session start or stop information has been received from upper layers for the measConfigAppLayerId:
3> set the appLayerSessionStatus in the MeasurementReportAppLayer message to the received value of session start or stop information;
2> if RAN visible application layer measurement report has been received from upper layers:
3> for each appLayerBufferLevel value in the received RAN visible application layer measurement report:
4> set the appLayerBufferLevel values in the appLayerBufferLevelList in the MeasurementReportAppLayer message to the buffer level values received from the upper layer in the order with the first appLayerBufferLevel value set to the newest received buffer level value, the second appLayerBufferLevel value set to the second newest received buffer level value, and so on until all the buffer level values received from the upper layer have been assigned or the maximum number of values have been set according to appLayerBufferLevel, if configured;
3> set the playoutDelayForMediaStartup in the MeasurementReportAppLayer message to the received value of playout delay for media startup in the RAN visible application layer measurement report, if any;
3> for each PDU session ID value indicated in the received RAN visible application layer measurement report, if any:
4> set the PDU-SessionID field in the pdu-SessionIdList in the MeasurementReportAppLayer message to the indicated PDU session ID value;
1> if the encoded RRC message is larger than the maximum supported size of one PDCP SDU:
2> if the RRC message segmentation is enabled based on the field rrc-SegAllowed received in appLayerMeasConfig:
3> initiate the UL message segment transfer procedure;
2> else:
3>discard the RRC message;
1> else:
2>submit the MeasurementReportAppLayer message to lower layers for transmission upon which the procedure ends.

Hereinafter, signalling radio bearers” (SRBs) are described.

SRBs are defined as Radio Bearers (RBs) that are used only for the transmission of RRC and NAS messages. More specifically, the following SRBs are defined:
SRB0 is for RRC messages using the CCCH logical channel;
SRB1 is for RRC messages (which may include a piggybacked NAS message) as well as for NAS messages prior to the establishment of SRB2, all using DCCH logical channel;
SRB2 is for NAS messages and for RRC messages which include logged measurement information, all using DCCH logical channel. SRB2 has a lower priority than SRB1 and may be configured by the network after AS security activation;
SRB3 is for specific RRC messages when UE is in (NG) EN-DC or NR-DC, all using DCCH logical channel;
SRB4 is for RRC messages which include application layer measurement report information, all using DCCH logical channel. SRB4 can only be configured by the network after AS security activation. SRB4 may be related to MCG and/or MN.
SRB5 is for specific RRC messages, e.g. QoE measurement reporting, when UE is in MR-DC, all using DCCH logical channel. SRB5 may be related to SCG and/or SN.

Meanwhile, the QoE measurement (i.e. application layer measurement) results has the lowest transmission priority but its size is huge, so when RAN is congested, network may not want to receive the QoE measurement reporting form UEs and may pause the QoE measurement reporting. However, if the QoE measurement reporting is paused, the QoE customer cannot immediately acquire the QoE measurement result and the QoE measurement result may become outdated during pause.

Therefore, various embodiments of the present disclosure provide solutions to provide the QoE measurement result from the UE to the network when the network is congested.

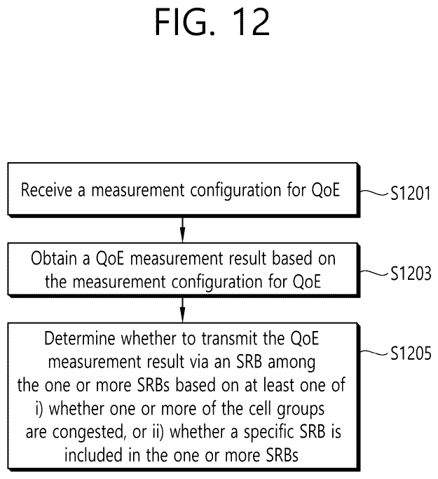

FIG. 12 shows an example of a method performed by a UE according to an embodiment of the present disclosure. The method may also be performed by a wireless device.

Referring to FIG. 12, in step S1201, the UE may receive a measurement configuration for QoE.

In step S1203, the UE may obtain a QoE measurement result based on the measurement configuration for QoE. One or more SRBs related to cell groups may be configured for reporting the QoE measurement result.

In step S1205, the UE may determine whether to transmit the QoE measurement result via an SRB among the one or more SRBs based on at least one of i) whether one or more of the cell groups are congested, or ii) whether a specific SRB is included in the one or more SRBs.

According to various embodiments, based on a determination to transmit the QoE measurement result, the UE may: select the SRB among the one or more SRBs; and transmit the QoE measurement result via the selected SRB.

According to various embodiments, based on a determination not to transmit the QoE measurement result, the UE may: pause transmitting the QoE measurement result; and store the QoE measurement result.

According to various embodiments, the cell groups may comprise a first cell group and a second cell group. The one or more SRBs may comprise a first SRB related to the first cell group. The specific SRB may be a second SRB related to the second cell group.

According to various embodiments, the first cell group may be a master cell group (MCG) and the second cell group may be a secondary cell group (SCG). The first SRB may be an SRB4, and the second SRB may be an SRB 5.

According to various embodiments, the UE may determine to transmit the QoE measurement result via the SRB among the one or more SRBs based on at least one of:
the first cell group being not congested; or
the first cell group being congested and the second cell group being not congested, and the second SRB being included in the one or more SRBs.

According to various embodiments, the SRB may be selected as the first SRB based on at least one of:
the first cell group being not congested, for the measurement configuration configured by the first cell group; or
the first cell group being not congested and the second SRB being not included in the one or more SRBs, for the measurement configuration configured by the second cell group.

According to various embodiments, the SRB may be selected as the second SRB based on at least one of:
the second cell group being not congested and the second SRB being included in the one or more SRBs, for the measurement configuration configured by the second cell group; or
the first cell being congested, the second cell group being not congested and the second SRB being included in the one or more SRBs, for the measurement configuration configured by the first cell group.

According to various embodiments, the UE may determine not to transmit the QoE measurement result via the SRB among the one or more SRBs based on at least one of:
the first cell group being congested, the second cell group being not congested and the second SRB being not included in the one or more SRBs; or
the first cell group and the second cell group being congested.

According to various embodiments, whether to transmit the QoE measurement result may be determined further based on whether an SRB related to a congested cell group is configured as a split SRB.

According to various embodiments, the UE may determine to transmit the QoE measurement result via the SRB among the one or more SRBs based on at least one of:
the first cell group being not congested; or
the first cell group being congested and the second cell group being not congested, and i) the first SRB being configured as the split bearer, or ii) the second SRB being included in the one or more SRBs.

According to various embodiments, the SRB may be selected as the first SRB based on at least one of:
the first cell group being not congested, for the measurement configuration configured by the first cell group;
the first cell group being not congested and the second SRB being not included in the one or more SRBs, for the measurement configuration configured by the second cell group;
the first cell group being congested, the second cell group being not congested and the first SRB being configured as the split SRB, for the measurement configuration configured by the first cell group; or
the first cell group being congested, the second cell group being not congested, the second SRB being not included in the one or more SRBs and the first SRB being configured as the split SRB, for the measurement configuration configured by the second cell group, and

According to various embodiments, the SRB may be selected as the second SRB based on at least one of:
the second cell group being not congested and the second SRB being included in the one or more SRBs, for the measurement configuration configured by the second cell group;
the first cell being congested, the second cell group being not congested, the first SRB being not configured as the split bearer and the second SRB being included in the one or more SRBs, for the measurement configuration configured by the first cell group; or
the first cell group being not congested, the second cell group being congested and the second SRB being included in the one or more SRBs and configured as the split bearer, for the measurement configuration configured by the second cell group.

According to various embodiments, the UE may determine not to transmit the QoE measurement result via the SRB among the one or more SRBs based on at least one of:
the first cell group being congested, the second cell group being not congested, the first SRB being not configured as the split bearer and the second SRB being not included in the one or more SRBs; or
the first cell group and the second cell group being congested.

According to various embodiments, the UE may receive a QoE measurement configuration (i.e., measurement configuration for QoE) from a first CG. The UE may performing the QoE measurement according to the configuration. The UE may receive a congestion indication for the first CG. The UE may select the first CG-specific SRB, if the first CG-specific SRB is configured as split SRB. The first CG-specific SRB may be configured for QoE reporting to the first CG. The UE may select the second CG-specific SRB, if the first CG-specific SRB is configured as non-split SRB and the second CG-specific SRB is configured. The second CG-specific SRB may be configured for QoE reporting to the second CG. The UE may transmit the QoE measurement result using the selected SRB.

According to various embodiments, for QoE configured by MN, the UE may receive a QoE measurement configuration from MCG. The UE may perform the QoE measurement according to the configuration. The UE may receive an MCG congestion indication. The UE may select SRB4, if SRB4 is configured as split SRB. The UE may select SRB5, if SRB4 is configured as non-split SRB and SRB5 is configured. The UE may transmit the QoE measurement result using the selected SRB.

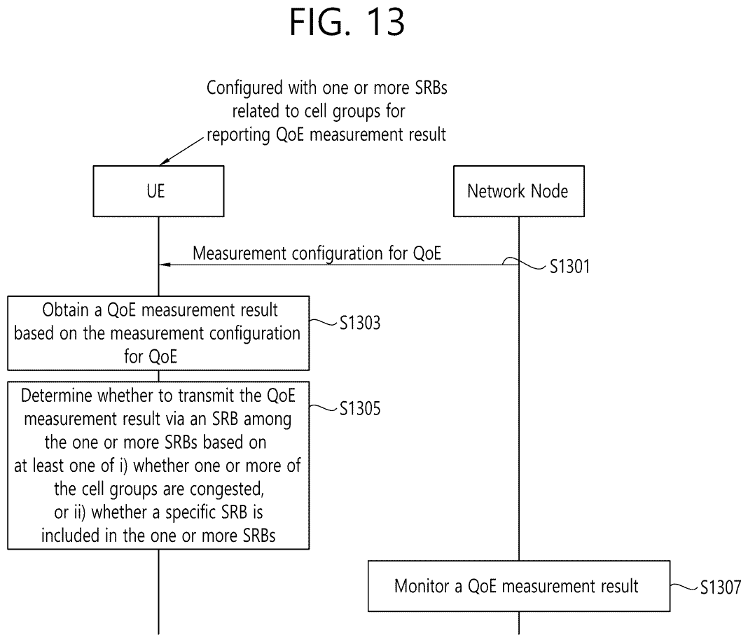

FIG. 13 shows an example of a signal flow for QoE measurement reporting according to an embodiment of the present disclosure.

Referring to FIG. 13, in step S1301, the network node may transmit, to the UE, a measurement configuration for QoE.

In step S1303, the UE may obtain a QoE measurement result based on the measurement configuration for QoE. The UE may be configured with one or more SRBs related to cell groups for reporting the QoE measurement result.

In step S1305, the UE may determine whether to transmit the QoE measurement result via an SRB among the one or more SRBs based on at least one of i) whether one or more of the cell groups are congested, or ii) whether a specific SRB is included in the one or more SRBs.

In step S1307, the network may monitor the QoE measurement result from the UE.

According to an embodiment, UE may select an SRB to transmit the QoE measurement report depending on whether MCG or SCG is congested, whether SRB4/5 is configured as split SRB, and/or whether SRB5 is configured. UE may transmit the QoE measurement report via the selected SRB.

According to another embodiment, the UE may pause the QoE measurement reporting depending on whether MCG or SCG is congested, whether SRB4/5 is configured as a split SRB, and/or whether SRB5 is configured.

For example, when MCG and SCG are not congested,
i) For QoE measurement configured by MN, UE may select SRB4 and transmit the QoE measurement result to the MCG via the SRB4.
ii) For QoE measurement configured by SN:
if SRB5 is configured, UE may select SRB5, and transmit the QoE measurement result to the SCG via the SRB5.
Else (i.e., If SRB5 is not configured), UE may select SRB4, and transmit the QoE measurement result to the SCG via the SRB4.

For example, when MCG is congested but SCG is not congested,
i) For QoE measurement configured by MN:
if SRB4 is configured as split SRB, UE may select SRB4 and transmit the QoE measurement result to the MCG via the SRB4.
Else if SRB5 is configured, UE may select SRB5 and transmit the QoE measurement result to the MCG via the SRB5.
Else, UE may pause the QoE measurement reporting, and store the QoE measurement result.
ii) For QoE measurement configured by SN:
If SRB5 is configured, UE may select SRB5 and transmit the QoE measurement result to the SCG via the SRB5.
Else if SRB4 is configured a split SRB, UE select SRB4 and transmit the QoE measurement result to the SCG via the SRB4.
Else, UE may pause the QoE measurement reporting, and store the QoE measurement result.

For example, when MCG is not congested but SCG is congested,
i) For QoE measurement configured by MN, UE may select SRB4 and transmit the QoE measurement result via the SRB4.
ii) For Qoe measurement configured by SN:
if SRB5 is configured as split SRB, UE may select SRB5 and transmit the QoE measurement result via the SRB5.
Else (i.e., if SRB5 is not configured, or SRB5 is configured but not as split SRB), UE may select SRB4 and transmit the QoE measurement result via the SRB4.

For example, when MCG and SCG are congested, UE may pause the QoE measurement reporting and store the QoE measurement result.

In some implementations, UE may determine whether a cell group is congested based on a congestion indication. Network may transmit a congestion indication (e.g., pauseReporting) to UE. The congestion indication may be defined per cell group, e.g., MCG and SCG. For example, if MCG is congested and network doesn't want to receive the QoE measurement reporting via MCG leg, i.e., Uu interface between UE and MCG, the network may transmit the congestion indication for MCG to the UE.

Network may transmit an alleviation indication to UE. The alleviation indication may be defined per cell group, e.g., MCG and SCG. For example, when the congestion happened on MCG is alleviated and network want to receive the QoE measurement reporting via MCG leg, the network may transmit the alleviation indication for MCG to the UE.

If UE receives a congestion indication for a certain CG, the UE may consider the CG is congested.

If UE receives an alleviation indication for a certain CG, the UE may consider the congestion is alleviated and the CG is not congested any longer.

In some implementations, the QoE measurement may be configured by MCG, i.e. master node, and/or SCG, i.e. secondary node.

If UE RRC receives QoE measurement results from upper layer, e.g. application layer, UE may determine whether the QoE measurement is configured by MN or SN (i.e., whether the configuration for QoE is received from MCG or SCG), and select SRB to transmit the QoE measurement reporting based on the determination.

In some implementations, the QoE measurement reporting may be initiated upon receiving the QoE measurement result (i.e. application layer measurement report information) from upper layers. When the QoE measurement reporting is initiated, UE may select a SRB to transmit the QoE measurement result/perform the QoE measurement reporting.

In some implementations, if the QoE measurement reporting is paused, UE may not transmit the QoE measurement report including the QoE measurement result to network. While the QoE measurement reporting is paused, UE may store the QoE measurement results.

When the QoE measurement reporting is resumed, UE may report the stored QoE measurement results to network.

Furthermore, the method in perspective of the UE described above in FIG. 12 may be performed by first wireless device 100 shown in FIG. 2, the wireless device 100 shown in FIG. 3, the first wireless device 100 shown in FIG. 4 and/or the UE 100 shown in FIG. 5.

More specifically, the UE comprises at least one transceiver, at least processor, and at least one computer memory operably connectable to the at least one processor and storing instructions that, based on being executed by the at least one processor, perform operations.

The operations comprise: receiving a measurement configuration for quality of experience (QoE); obtaining a QoE measurement result based on the measurement configuration for QoE, wherein one or more signalling radio bearers (SRBs) related to cell groups are configured for reporting the QoE measurement result; and determining whether to transmit the QoE measurement result via an SRB among the one or more SRBs based on at least one of i) whether one or more of the cell groups are congested, or ii) whether a specific SRB is included in the one or more SRBs.

Furthermore, the method in perspective of the UE described above in FIG. 12 may be performed by a software code 105 stored in the memory 104 included in the first wireless device 100 shown in FIG. 4.

More specifically, at least one computer readable medium (CRM) stores instructions that, based on being executed by at least one processor, perform operations comprising: receiving a measurement configuration for quality of experience (QoE); obtaining a QoE measurement result based on the measurement configuration for QoE, wherein one or more signalling radio bearers (SRBs) related to cell groups are configured for reporting the QoE measurement result; and determining whether to transmit the QoE measurement result via an SRB among the one or more SRBs based on at least one of i) whether one or more of the cell groups are congested, or ii) whether a specific SRB is included in the one or more SRBs.

Furthermore, the method in perspective of the UE described above in FIG. 12 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving a measurement configuration for quality of experience (QoE); obtaining a QoE measurement result based on the measurement configuration for QoE, wherein one or more signalling radio bearers (SRBs) related to cell groups are configured for reporting the QoE measurement result; and determining whether to transmit the QoE measurement result via an SRB among the one or more SRBs based on at least one of i) whether one or more of the cell groups are congested, or ii) whether a specific SRB is included in the one or more SRBs.

Furthermore, the method in perspective of the network node described above may be performed by second wireless device 100 shown in FIG. 2, the device 100 shown in FIG. 3, and/or the second wireless device 200 shown in FIG. 4.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a measurement configuration for quality of experience (QoE); and monitoring a QoE measurement result based on the measurement configuration for QoE from the UE. One or more signalling radio bearers (SRBs) related to cell groups may be configured to the UE for reporting the QoE measurement result. Whether to transmit the QoE measurement result via an SRB among the one or more SRBs may be determined based on at least one of i) whether one or more of the cell groups are congested, or ii) whether a specific SRB is included in the one or more SRBs.

The present disclosure can have various advantageous effects.

For example, when a Uu interface between UE and a certain CG is congested, UE may report the QoE measurement results using another CG not congested so that the network can obtain the QoE measurement results as soon as the QoE measurement is completed.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a user equipment (UE) in a wireless communication system, the method comprising:
receiving a measurement configuration for quality of experience (QoE);
obtaining a QoE measurement result based on the measurement configuration for QoE, wherein one or more signalling radio bearers (SRBs) related to cell groups are configured for reporting the QoE measurement result; and
determining whether to transmit the QoE measurement result via an SRB among the one or more SRBs based on at least one of i) whether one or more of the cell groups are congested, or ii) whether a specific SRB is included in the one or more SRBs.

2. The method of claim 1, based on a determination to transmit the QoE measurement result, further comprising:
selecting the SRB among the one or more SRBs; and
transmitting the QoE measurement result via the selected SRB.

3. The method of claim 1, based on a determination not to transmit the QoE measurement result, further comprising:
pausing transmitting the QoE measurement result; and
storing the QoE measurement result.

4. The method of claim 1, wherein the cell groups comprise a first cell group and a second cell group,
wherein the one or more SRBs comprise a first SRB related to the first cell group, and
wherein the specific SRB is a second SRB related to the second cell group.

5. The method of claim 4, wherein the first cell group is a master cell group (MCG) and the second cell group is a secondary cell group (SCG), and
wherein the first SRB is an SRB4, and the second SRB is an SRB 5.

6. The method of claim 4, further comprising:
determining to transmit the QoE measurement result via the SRB among the one or more SRBs based on at least one of:
the first cell group being not congested; or
the first cell group being congested and the second cell group being not congested, and the second SRB being included in the one or more SRBs.

7. The method of claim 6, wherein the SRB is selected as the first SRB based on at least one of:
the first cell group being not congested, for the measurement configuration configured by the first cell group; or
the first cell group being not congested and the second SRB being not included in the one or more SRBs, for the measurement configuration configured by the second cell group, and
wherein the SRB is selected as the second SRB based on at least one of:
the second cell group being not congested and the second SRB being included in the one or more SRBs, for the measurement configuration configured by the second cell group; or
the first cell being congested, the second cell group being not congested and the second SRB being included in the one or more SRBs, for the measurement configuration configured by the first cell group.

8. The method of claim 4, further comprising:
determining not to transmit the QoE measurement result via the SRB among the one or more SRBs based on at least one of:
the first cell group being congested, the second cell group being not congested and the second SRB being not included in the one or more SRBs; or
the first cell group and the second cell group being congested.

9. The method of claim 4, wherein whether to transmit the QoE measurement result is determined further based on whether an SRB related to a congested cell group is configured as a split SRB.

10. The method of claim 9, further comprising:
determining to transmit the QoE measurement result via the SRB among the one or more SRBs based on at least one of:
the first cell group being not congested; or
the first cell group being congested and the second cell group being not congested, and i) the first SRB being configured as the split bearer, or ii) the second SRB being included in the one or more SRBs.

11. The method of claim 10, wherein the SRB is selected as the first SRB based on at least one of:
the first cell group being not congested, for the measurement configuration configured by the first cell group;
the first cell group being not congested and the second SRB being not included in the one or more SRBs, for the measurement configuration configured by the second cell group;
the first cell group being congested, the second cell group being not congested and the first SRB being configured as the split SRB, for the measurement configuration configured by the first cell group; or
the first cell group being congested, the second cell group being not congested, the second SRB being not included in the one or more SRBs and the first SRB being configured as the split SRB, for the measurement configuration configured by the second cell group, and
wherein the SRB is selected as the second SRB based on at least one of:
the second cell group being not congested and the second SRB being included in the one or more SRBs, for the measurement configuration configured by the second cell group;
the first cell being congested, the second cell group being not congested, the first SRB being not configured as the split bearer and the second SRB being included in the one or more SRBs, for the measurement configuration configured by the first cell group; or
the first cell group being not congested, the second cell group being congested and the second SRB being included in the one or more SRBs and configured as the split bearer, for the measurement configuration configured by the second cell group.

12. The method of claim 9, further comprising:
determining not to transmit the QoE measurement result via the SRB among the one or more SRBs based on at least one of:
the first cell group being congested, the second cell group being not congested, the first SRB being not configured as the split bearer and the second SRB being not included in the one or more SRBs; or
the first cell group and the second cell group being congested.

13. The method of claim 1, wherein the UE is in communication with at least one of a network or autonomous vehicles.

14. A user equipment (UE) adapted to operate in a wireless communication system, the UE comprising:
at least one transceiver;
at least processor; and
at least one computer memory operably connectable to the at least one processor and storing instructions that, based on being executed by the at least one processor, perform operations comprising:
receiving a measurement configuration for quality of experience (QoE);
obtaining a QoE measurement result based on the measurement configuration for QoE, wherein one or more signalling radio bearers (SRBs) related to cell groups are configured for reporting the QoE measurement result; and
determining whether to transmit the QoE measurement result via an SRB among the one or more SRBs based on at least one of i) whether one or more of the cell groups are congested, or ii) whether a specific SRB is included in the one or more SRBs.

15. A network node adapted to operate in a wireless communication system, the network node comprising:
at least one transceiver;
at least processor; and
at least one computer memory operably connectable to the at least one processor and storing instructions that, based on being executed by the at least one processor, perform operations comprising:
transmitting, to a user equipment (UE), a measurement configuration for quality of experience (QoE); and
monitoring a QoE measurement result based on the measurement configuration for QoE from the UE,
wherein one or more signalling radio bearers (SRBs) related to cell groups are configured to the UE for reporting the QoE measurement result, and
wherein whether to transmit the QoE measurement result via an SRB among the one or more SRBs is determined based on at least one of i) whether one or more of the cell groups are congested, or ii) whether a specific SRB is included in the one or more SRBs.

16-18. (canceled)
